(19) United States
(12) Patent Application Publication
(10) Pub. No.: US 2011/0045691 A1
(43) Pub. Date: Feb. 24, 2011

(54) EASILY INSTALLABLE NETWORK WIRING DEVICE

(75) Inventors: Jerry Su, Taipei (TW); Kihai Lee, Taipei (TW)

Correspondence Address: SCHMEISER, OLSEN & WATTS, 22 CENTURY HILL DRIVE, SUITE 302, LATHAM, NY, 12110, US

(73) Assignee: HSING CHAU INDUSTRIAL CO., LTD., TAIPEI (TW)

(21) Appl. No.: 12/545,895

(22) Filed: Aug. 24, 2009

(51) Int. Cl. H01R 13/60

(52) U.S. Cl. 439/540.1

(57) ABSTRACT

An easily installable network wiring device includes a sliding cable hub body and a fixed frame. The sliding cable hub body includes a front panel and the sliding cable hub body is installed into the fixed frame through an opening of the fixed frame, and slid horizontally along an edge of the opening, such that two first slide latching portions of the front panel and two corresponding first notches on the opening are disposed alternately with one another, and a positioning portion and a second notch are provided for latching the sliding cable hub body with the fixed frame. Therefore, the sliding cable hub body can be installed onto the fixed frame easily, and achieve the effects of lowering the level of difficulty of the construction, enhancing the stability of the installation, and saving the time required for the construction.

### FIELD OF THE INVENTION

The present invention relates to a network wiring device, in particular to an easily installable network wiring device that provides a quick installation.

### BACKGROUND OF THE INVENTION

Present network installing devices generally come with a complicated wiring circuit, and various different circuits are installed and connected to a network distribution box, and different network modules are installed in a single distribution box according to actual requirements, and thus the installation, maintenance, and operation of these complicated circuits and modules require tremendous care and patience of technicians.

Since the foregoing integrated network distribution box is used extensively in present existing distribution rooms, therefore the complicated distribution box installing modules make the maintenance more difficult and less efficient for technicians, if any one of the wiring modules or circuits fails and requires a replacement or maintenance.

With reference to FIG. 1 for a conventional network wiring device, the network wiring device comprises a fixed frame 11 and a plurality of hub bodies 13, and the fixed frame 11 includes an opening 15 for containing the hub bodies 13, and a plurality of elastic bumps 17 disposed on the hub body 13 and fixed to an edge of the opening 15 for mounting the hub bodies 13 onto the fixed frame 11.

With reference to FIG. 2 for a cross-sectional view of a conventional network wiring device, showing the Section A-A″ of FIG. 1, the elastic bumps 17 abut the edge of the opening of the fixed frame 11 to mount the hub bodies 13 onto the fixed frame 11. Although this fixing method provides a secured connection, yet it also gives a high level of difficulty to the removal of the hub body 13 from the fixed frame 11 for circuit maintenance or replacement, since the elastic bumps 17 cannot be released from the status of being latched at the opening 15 of the fixed frame 11 quickly and effectively. This drawback greatly increases the level of difficulty of removing the wiring module. After the elastic bumps 17 become elastically fatigue, forces for plugging or unplugging a network cable at a front end of the hub body 13 or wire bonding a network cable at the rear end of the hub body 13 will push the hub body 13 away from the fixed frame 11.

### SUMMARY OF THE INVENTION

In view of the shortcomings of the conventional network wiring device, the inventor of the present invention based on years of experience in the related industry to conduct extensive researches and experiments, and finally developed an easily installable network wiring device that uses a simple horizontally sliding structure to replace the traditional fixing and latching structure and provide an easy and quick way of installing the network wiring device.

To achieve the foregoing objective, the present invention provides an easily installable network wiring device, comprising: a sliding cable hub body, at least one network interface installed on the network wiring device, two slide latching portions and a slide positioning portion formed on both upper and lower ends of the sliding cable hub body respectively; and a fixed frame, having an opening for horizontally sliding the sliding cable hub body and accommodating the sliding cable hub body, and a plurality of first slots and a plurality of second slots disposed at an edge of the opening for containing the slide latching portions and the slide positioning portions respectively; wherein the sliding cable hub body is installed in the fixed frame through the opening and slid horizontally along the edge of the opening to separate and arrange the slide latching portions and the corresponding first notches alternately, and align the slide positioning portions with the second notches respectively to achieve the positioning effect to latch the sliding cable hub body with the fixed frame.

In a first preferred embodiment of the present invention, the sliding cable hub body further comprises a front panel and a rear panel, and the slide latching portion is formed on both external sides of the upper and lower ends of the front panel separately, and the slide positioning portion is formed at the central position of the upper and lower ends of the rear panel separately.

To provide a quickly removable and easily installable network wiring device, the present invention further forms a positioning groove at the central position of upper and lower ends of the front panel separately, such that when it is necessary to remove the sliding cable hub body from the fixed frame, a pressure is applied to press the slide positioning portions into the corresponding positioning grooves to release the fixed status.

In addition, the first ditch is formed between a rear end of the slide latching portion and an external panel of the front panel separately, and the first ditches are provided for sliding the sliding cable hub body horizontally on the fixed frame, and a positioning gap is formed between the slide positioning portion and the external panel of the front panel separately, and the positioning gaps are narrower than the first ditches, such that the slide positioning portions can be latched into the second notches.

In the first preferred embodiment of the present invention, a circuit board is installed between the front panel and the rear panel for electrically connecting the network interfaces.

In the first preferred embodiment of the present invention, a hook portion is formed on two external sides of upper and lower ends of the rear panel separately, and the hook portions are latched at positions corresponding to a U-shaped slot of the slide latching portions, such that the front panel and the rear panel can be latched with one another securely through the hook portions and the U-shaped slots.

To enhance the secured connection of the fixed status, the first preferred embodiment of the present invention includes two protrusions disposed at each slide positioning portion and corresponding to two ports of each second notch respectively, and the two ports are provided for enhancing the secured fixing and latching effect.

To achieve the foregoing objective, the present invention further provides another preferred embodiment of an easily installable network wiring device, comprising: a sliding cable hub body, at least one network interface installed on the sliding cable hub body, a slide latching portion formed on both upper and lower ends of the sliding cable hub body separately, a slide positioning portion formed at one of the upper and lower ends; and a fixed frame, including an opening for sliding the sliding cable hub body horizontally and accommodating the sliding cable hub body, and a plurality of first slots disposed at an edge of the opening of a second notch for accommodating the slide latching portions and the slide positioning portions respectively, wherein the sliding cable hub body is installed into the fixed frame through the opening, and slid horizontally along the edge of the opening, such that the slide latching portions and the corresponding first notches are arranged alternately with one another, and the slide positioning portions are aligned with the second notches to achieve a fixed status, so as to latch the sliding cable hub body with the fixed frame.

Unlike the prior art that adopts the elastic bumps for the installation, the invention uses the corresponding slide latching portions and first notches arranged alternately with one another to achieve a fixed latching status, such that the sliding cable hub body will not be pushed by a force of plugging or unplugging a network cable at the front end of the cable hub or wire bonding a network cable at the rear of the cable hub. As a result, the sliding cable hub body will be pushed and separated from the fixed frame easily.

### BRIEF DESCRIPTION OF THE DRAWINGS

FIG. 1 is a perspective view of a conventional network wiring device;

FIG. 2 is a cross-sectional view of a conventional network wiring device;

FIG. 3 is a perspective view of an easily installable network wiring device in accordance with a first preferred embodiment of the present invention;

FIG. 4 is a perspective view of a sliding cable hub body the present invention in accordance with a first preferred embodiment of the present invention;

FIG. 5 is a schematic view of using an easily installable network wiring device in accordance with the present invention;

FIG. 6 is a schematic view of an inserted status of an easily installable network wiring device in accordance with the present invention;

FIG. 7 is a schematic view of a fixed status of an easily installable network wiring device in accordance with the present invention;

FIG. 8 is a cross-sectional view of Section BB′ of FIG. 5;

FIG. 9 is a cross-sectional view of Section CC′ of FIG. 5;

FIG. 10 is a front view of cross-section DD′ of FIG. 7 along the X-axis direction;

FIG. 11 is a schematic view of releasing the fixed status as depicted in FIG. 10;

FIG. 12 is a perspective view of assembling a sliding cable hub body in accordance with a second preferred embodiment of the present invention;

FIG. 13 is a rear view of a sliding cable hub body in accordance with a second preferred embodiment of the present invention;

FIG. 14 is a schematic view of a fixed frame in accordance with a second preferred embodiment of the present invention;

FIG. 15 is a perspective view of assembling a sliding cable hub body in accordance with a second preferred embodiment of the present invention;

FIG. 16 is a rear view of a sliding cable hub body in accordance with a second preferred embodiment of the present invention; and

FIG. 17 is a schematic view of a fixed frame in accordance with a second preferred embodiment of the present invention.

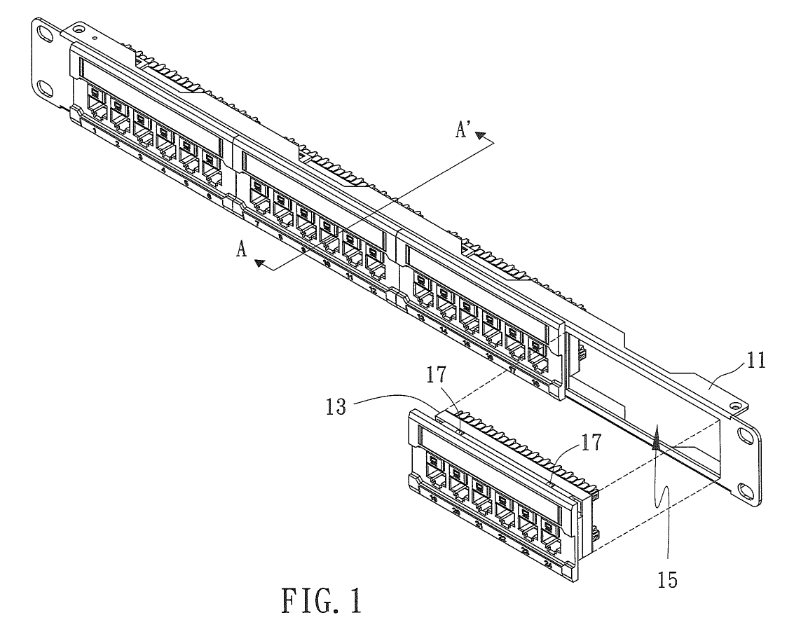

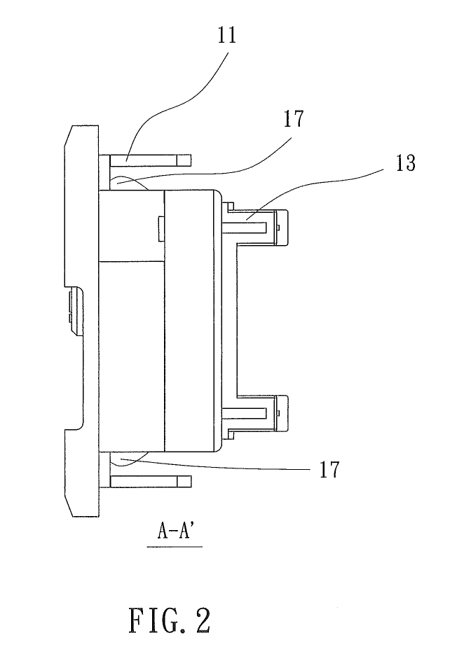

### DESCRIPTION OF THE PREFERRED EMBODIMENTS

Other features and advantages of the present invention will become apparent in the following detailed description of the preferred embodiments with reference to the accompanying drawings.

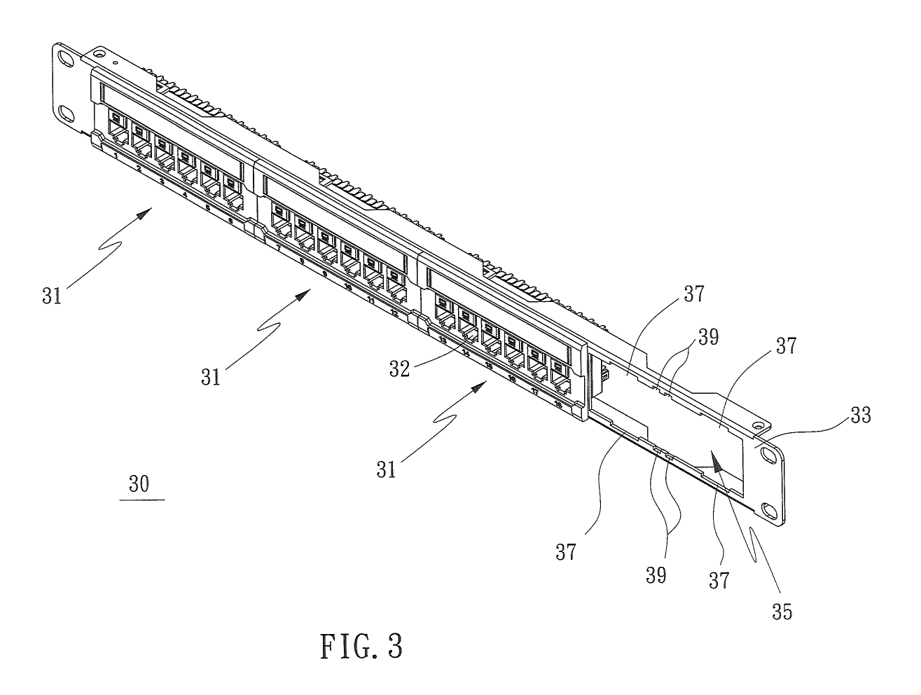

With reference to FIG. 3 for a perspective view of an easily installable network wiring device in accordance with a first preferred embodiment of the present invention, the network wiring device 30 comprises a plurality of sliding cable hub bodies 31 and a fixed frame 33, and each sliding cable hub body 31 installs a plurality of network interfaces 32. The fixed frame 33 includes an opening 35 corresponding to each sliding cable hub body 31, and a plurality of first slots 37 and a plurality of second slots 39 formed on an edge of the opening 35. Each sliding cable hub body 31 is accommodated and mounted onto the fixed frame 33 through the opening 35.

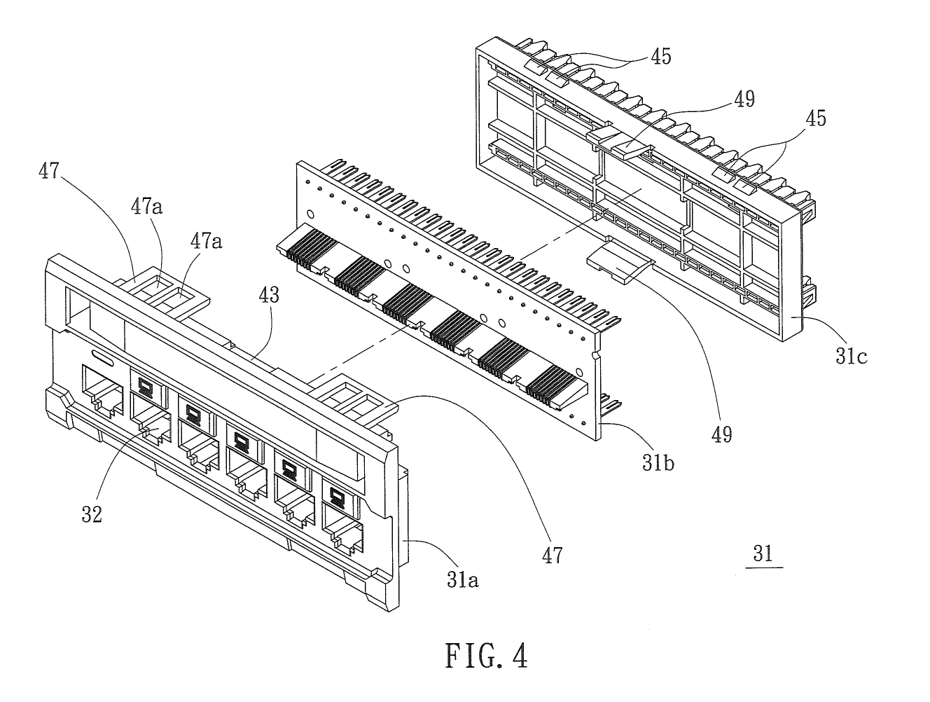

With reference to FIG. 4 for a perspective view of a sliding cable hub body in accordance with a first preferred embodiment of the present invention, the sliding cable hub body 31 comprises a front panel 31a, a circuit board 31b and a rear panel 31c, wherein the front panel 31a and the rear panel 31c are latched with one another to fix the circuit board 31b between the front panel 31a and the rear panel 31c. The circuit board 31b is electrically connected to the network interfaces 32.

In FIG. 4, the front panel 31a includes a slide latching portion 47 (only the upper end of the slide latching portion 47 is shown in the figure) formed separately on two external edges of both upper and lower ends of the front panel 31a, and a slide positioning portion 49 formed at the central position of both upper and lower ends of the rear panel 31c separately. In addition, a positioning groove 43 (only the upper end of the positioning groove 43 is shown in the figure) is formed at the central position of both upper and lower ends the front panel 31a separately, and a hook portion 45 (only the upper end of the hook portion 45 is shown in the figure) formed on two external sides of both upper and lower ends of the rear panel 31c separately.

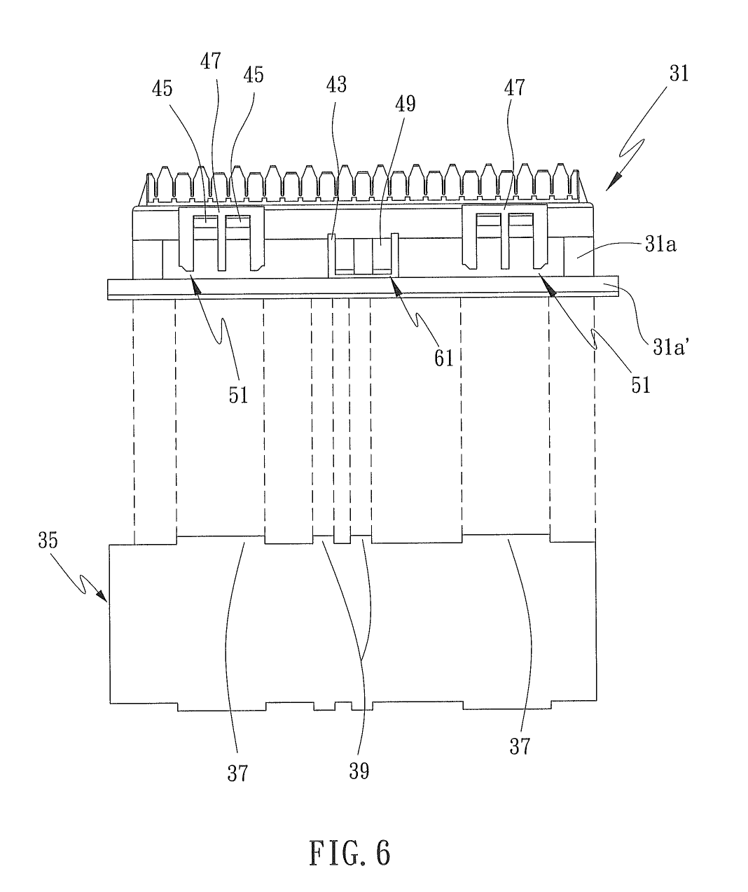

In the preferred embodiment of the present invention, the slide latching portions 47 includes a plurality of U-shaped slots 47a (with a U-shaped structure as shown in FIG. 6), and the U-shaped slots 47a correspond to the hook portions 45 to latch the front panel 31a with the rear panel 31c. In FIG. 4, each slide latching portion 47 of this preferred embodiment includes two U-shaped slots 47a, and the two U-shaped slots 47a include two hook portions 45 for latching the U-shaped slots 47a respectively. However, those ordinarily skilled in the art should understand that the quantity of U-shaped slots 47a and hook portions 45 is used for the purpose of illustrating the present invention, but the invention is not limited to such arrangement only.

In FIG. 4, the positioning groove 43 is provided for accommodating the slide positioning portion 49, when an external force is applied to press the slide positioning portion 49 into the positioning groove 43, and also used for releasing the sliding cable hub body 31 from the fixed status at the fixed frame 33, and the detailed description will be given below.

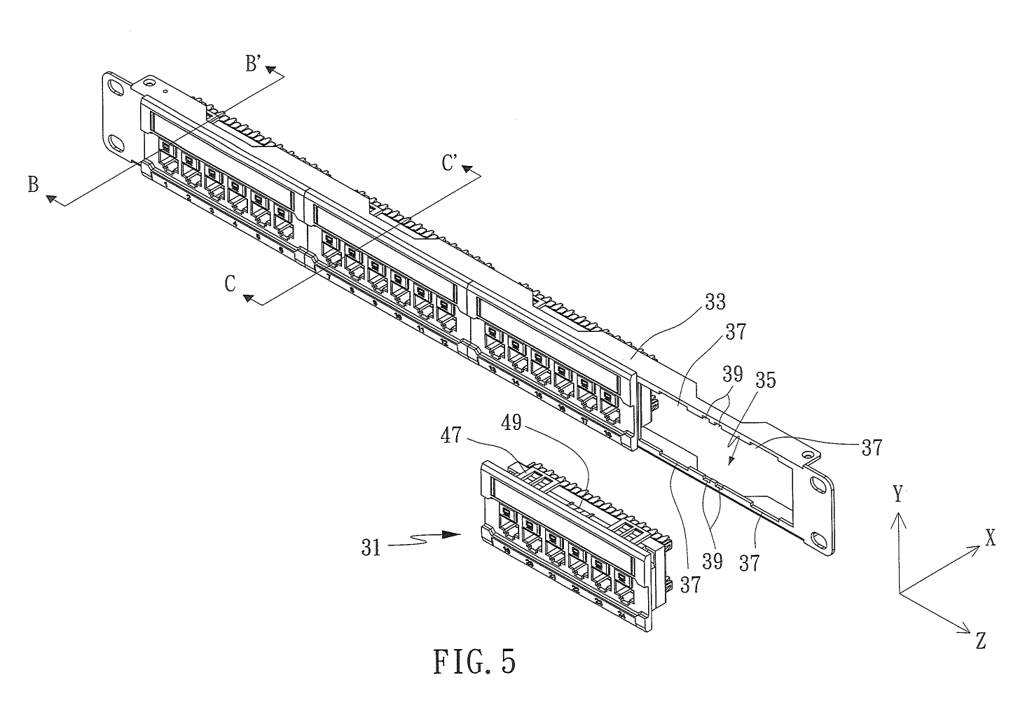

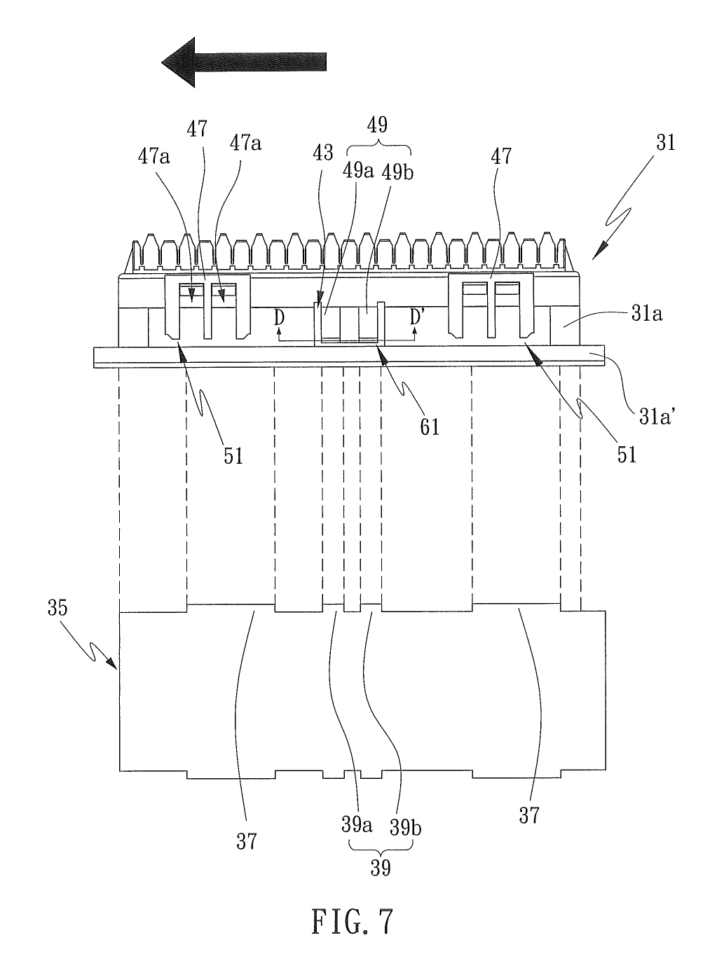

With reference to FIG. 5 for a schematic view of using an easily installable network wiring device in accordance with the present invention, the present invention can install each sliding cable hub body 31 onto the fixed frame 33 quickly and easily by placing the sliding cable hub body 31 vertically (which is along the X-axis direction) into the opening 35 of the fixed frame 33 first, such that the slide latching portions 47 are aligned with the corresponding first notches 37, and the slide positioning portions 49 are deviated from and not aligned with the corresponding second notches 39. After the sliding cable hub bodies 31 are positioned (refer to FIGS. 6 and 7 for more details), the slide positioning portions 49 will be pressed into the corresponding positioning grooves 43 (not shown in FIG. 5) respectively. The opening 35 in the transversal direction (which is the Z-axis direction) is wider than the width of the sliding cable hub body 31 in the transversal direction (which is the Z-axis direction), such that the sliding cable hub body 31 includes a space for sliding horizontally in the opening 35.

After the sliding cable hub body 31 is placed vertically into the opening 35, the sliding cable hub body 31 is slid horizontally, wherein the sliding cable hub body 31 is moved to the left (which is the negative Z-axis direction) in this preferred embodiment. If the sliding cable hub body 31 slides to the left, the slide positioning portions 49 will be aligned with the corresponding second notches 39, and the slide positioning portions 49 will prop the corresponding second notches 39 upward, such that the sliding cable hub body 31 is entered into a fixed status. Now, the slide latching portions 47 and the corresponding first notches 37 are disposed alternately with one another. Finally, the sliding cable hub body 31 can be mounted onto the fixed frame 33.

Since the slide latching portions 47 and the corresponding first notches 37 are arranged alternately with one another, this fixing method provides a stable movement along the X-axis direction. In other words, the sliding cable hub body 31 of the present invention is slid in the Z-axis direction before the sliding cable hub body 31 can be moved in the X-axis direction and separated from the fixed frame 33.

With reference to FIGS. 6 and 7, FIG. 6 shows a schematic view of an inserted status of an easily installable network wiring device in accordance with the present invention, and FIG. 7 shows a schematic view of a fixed status of an easily installable network wiring device in accordance with the present invention, and both FIGS. 6 and 7 are divided into upper and lower drawings, wherein the upper drawing shows a top view (which is a view in the negative Y-axis direction of FIG. 5) of the sliding cable hub body 31, and the lower drawing shows a front view of the opening 35 (which is a view in the X-axis direction of FIG. 5).

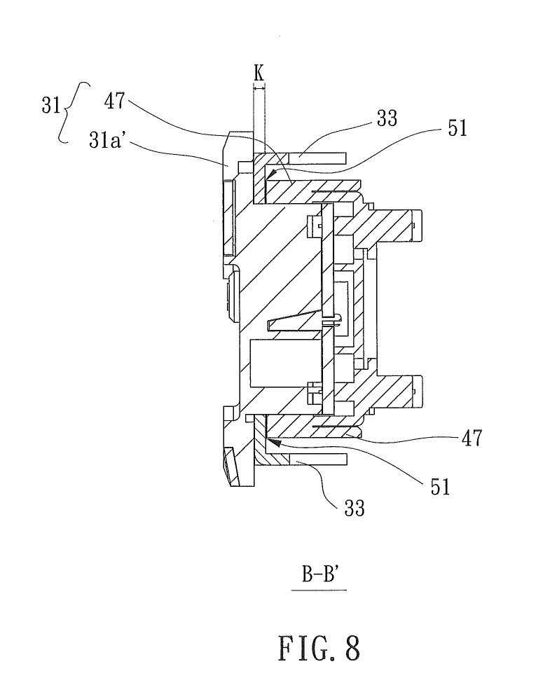

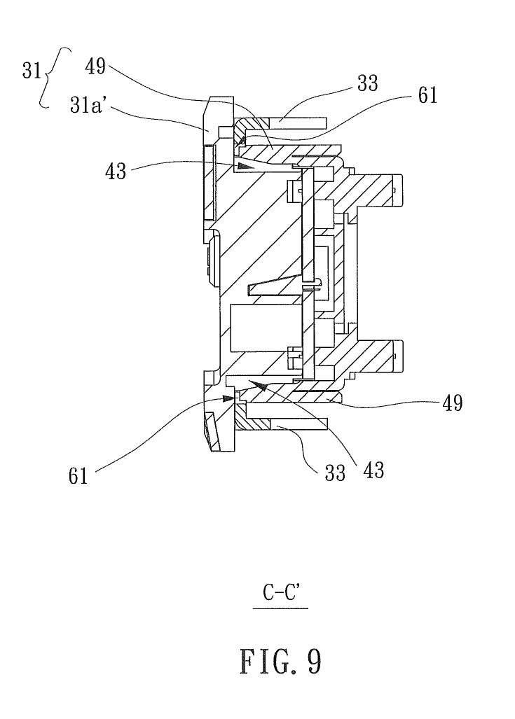

With reference to FIG. 6 for a position of placing the sliding cable hub body 31 into the opening 35, the slide latching portions 47 and the first notches 37 are aligned with one another, and the slide latching portions 47 and the first notches 37 allow the sliding cable hub body 31 to be placed into the opening 35 without any hindrance. After the sliding cable hub body 31 is placed into the opening 35, the sliding cable hub body 31 is stopped at a position of an external panel 31a′ of the front panel 31a (depending on the relation as shown in FIGS. 8 and 9), and an edge of the opening 35 (which is the thickness of material of the fixed frame 33, and will be entered into a plurality of first ditches 51 between a rear end of the slide latching portions 47 and the external panel 31a′ depending on the relation as shown in FIGS. 8 and 9), and the sliding cable hub body 31 can be slid horizontally in the fixed frame 33. Now, the slide positioning portions 49 are not aligned with the second notches 39, and thus the slide positioning portions 49 can be pressed into the corresponding positioning grooves 43 by the edge of the opening 35.

With reference to FIG. 7 for a position of the sliding cable hub body 31 at the fixed status, the slide latching portions 47 and the corresponding first notches 37 are arranged alternately with one another, such that the sliding cable hub body 31 will not move along the X-axis direction as shown in FIG. 5. In FIG. 7, the slide positioning portion 49 is aligned with the second notch 39 precisely, such that the slide positioning portion 49 originally pressed into the positioning groove 43 is propped upwardly into the second notch 39 to achieve the fixed status, and the sliding cable hub body 31 will not move along the Z-axis direction as shown in FIG. 5. In a preferred embodiment of the invention, the slide positioning portion 49 includes two protrusions 49a, 49b corresponding to two ports 39a, 39b of the second notch 39 respectively to provide a better fixed status. However, those ordinarily skilled in the art should understand that the quantity of protrusions 49a, 49b and ports 39a, 39b is used for the purpose of illustrating the present invention, but the invention is not limited to such arrangement only.

In the preferred embodiment of the present invention as shown in FIGS. 6 and 7, each slide latching portion 47 includes two U-shaped slots 47a.

With reference to FIG. 8 for a cross-sectional view of Section BB′ as depicted in FIG. 5, FIG. 8 corresponds to the fixed status of FIG. 7. In other words, FIG. 8 shows the cross-sectional view of alternately arranged positions when the slide latching portions 47 and corresponding first notches 37 (not shown in the figure) are disposed and arranged alternately. When the sliding cable hub body 31 is slid horizontally, the sliding cable hub body 31 is moved parallelly with respect to the first ditch 51 and at the alternately arranged positions, and the slide latching portion 47 at the position of the first ditch 51 will prop against the fixed frame 33, such that the sliding cable hub body 31 will not move along the X-axis direction as shown in FIG. 5. In FIG. 8, the thickness K of the material of the fixed frame 33 is approximately equal to the width of the first ditch 51, such that when the sliding cable hub body 31 is placed into the opening 35 (not shown in the figure) of the fixed frame 33, the external panel 31a′ stops the sliding cable hub body 31 from moving further along the positive X-axis direction as shown in FIG. 5.

With reference to FIG. 9 for a cross-sectional view of Section CC′ as depicted in FIG. 5, FIG. 9 corresponds to the fixed status of FIG. 7. In other words, FIG. 9 shows a cross-sectional view of an aligned position when the slide positioning portion 49 is aligned with the corresponding second notch 39 (not shown in the figure), a positioning gap 61 is situated between the slide positioning portion 49 and the external panel 31a′, wherein the positioning gap 61 is narrower than the first ditch 51. At the fixed status as shown in FIG. 7, the slide positioning portion 49 can be propped into the second notch 39 and the sliding cable hub body 31 will not move along the Z-axis direction as shown in FIG. 5. When it is necessary to release the fixed status, a pressure is applied to press the slide positioning portion 49 into the positioning groove 43, and the slide positioning portion 49 will no longer be situated in the second notch 39 and the fixed status will be released, such that the sliding cable hub body 31 can move along the Z-axis direction as shown in FIG. 5.

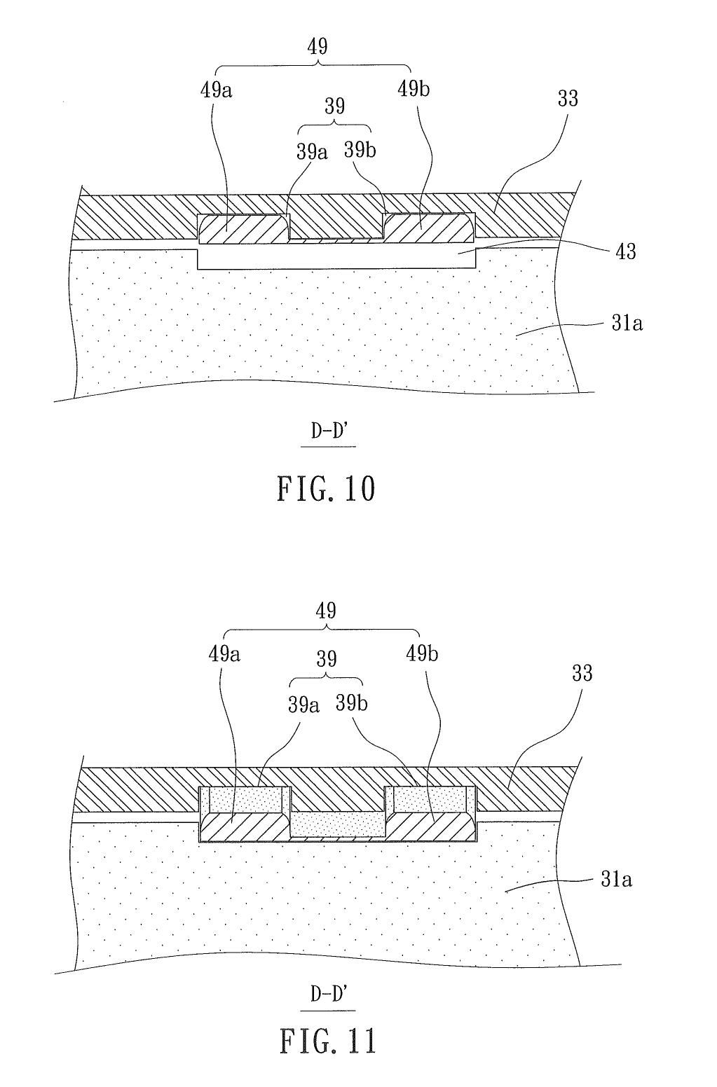

With reference to FIG. 10 for a front view of Section DD′ as depicted in FIG. 7 along the X-axis direction, FIG. 10 shows the fixed status, wherein two protrusions 49a, 49b of the slide positioning portion 49 are aligned with two ports 39a, 39b of the second notch 39 respectively, and thus the elasticity of the protrusions 49a, 49b props the positioning groove of the front panel 31a into the two ports 39a, 39b to enter into the fixed status. The slide positioning portion 49 can be formed integrally by a plastic material or any other material with a resilience force.

With reference to FIG. 11 for a schematic view of releasing a fixed status, a pressure is applied to press the slide positioning portions 49 into the corresponding positioning grooves 39 to release the fixed status. In FIG. 11, the two protrusions 49a, 49b of the slide positioning portion 49 are separated from two ports 39a, 39b of the second notch 39 and entered into the positioning grooves 39 respectively, so that the sliding cable hub body 31 is released from the fixed status and can be slid horizontally.

In an easily installable network wiring device of the present invention, the sliding cable hub body 31 having the slide latching portions 47, the slide positioning portions 49, the positioning grooves 43, the first ditches 51, the positioning gaps 61, and the opening 35, the first notches 37 and the second notches 39 on the fixed frame 33 provides a quick installation to improve the stability of assembling procedure and the working efficiency of technicians. The aforementioned embodiment is a preferred embodiment, but the quantity of slide latching portions 47 and slide positioning portions 49 can be changed. In other words, any quantity of latching portions 47 and slide positioning portion 49 can be used with the first and second notches according to actual requirements.

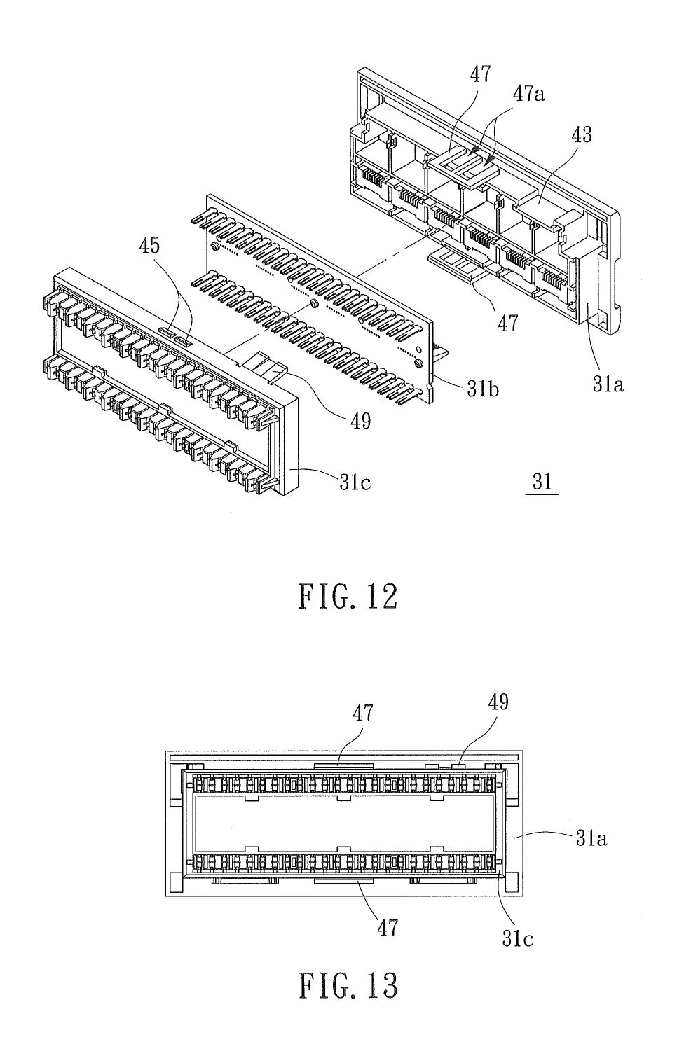

With reference to FIG. 12 for a perspective view of assembling a sliding cable hub body in accordance with a second preferred embodiment of the present invention, the present invention includes at least two slide latching portions 47 formed on the front panel 31a of the sliding cable hub body 31 and disposed separately on both upper and lower ends of the front panel 31a, such that forces can be exerted uniformly, in order to uniformly apply a force to latch the sliding cable hub body 31 with the fixed frame. Preferably, the slide latching portions 47 are disposed at the central position of the upper and lower ends of the front panel 31a, but of course, they can be situated at other positions as well. In addition, each of the two slide latching portions 47 of the preferred embodiment includes two U-shaped slots 47a, and a plurality of hook portions 45 formed on the rear panel 31c for latching the front panel 31a with the rear panel 31c. A second preferred embodiment just includes a slide positioning portion 49 and a corresponding positioning groove 43 disposed on the front panel 31a.

With reference to FIG. 13 for a rear view of a sliding cable hub body in accordance with a second preferred embodiment of the present invention, a positional relation between the two slide latching portions 47 and the slide positioning portion 49 is shown. In fact, the slide positioning portion 49 can be disposed at any one of the upper and lower ends of the front panel 31a and at any position not overlapped with the slide latching portion 47. In other words, the slide positioning portion 49 as shown in FIG. 13 is situated at the upper right corner, but it can also be situated at the lower right corner, lower left corner, upper left corner or any other position. In addition, a plurality of slide positioning portions 49 can be designed on the front panel 31a. For example, the slide positioning portions 49 can be disposed on both upper and lower ends of the front panel 31a separately.

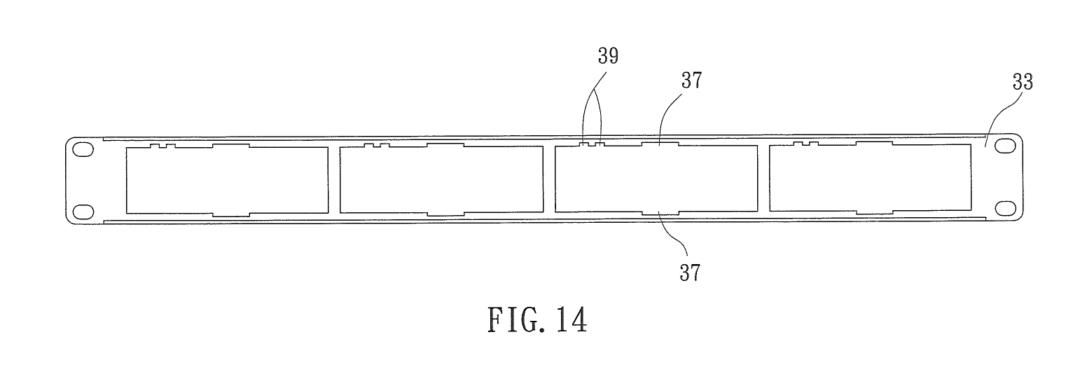

With reference to FIG. 14 for a schematic view of a fixed frame in accordance with a second preferred embodiment of the present invention, the quantity of slide latching portions 47 and slide positioning portions 49 varies with the quantity of the corresponding first notches 37 and second notches 39, so that the sliding cable hub body can be mounted onto the fixed frame 33 by the aforementioned method.

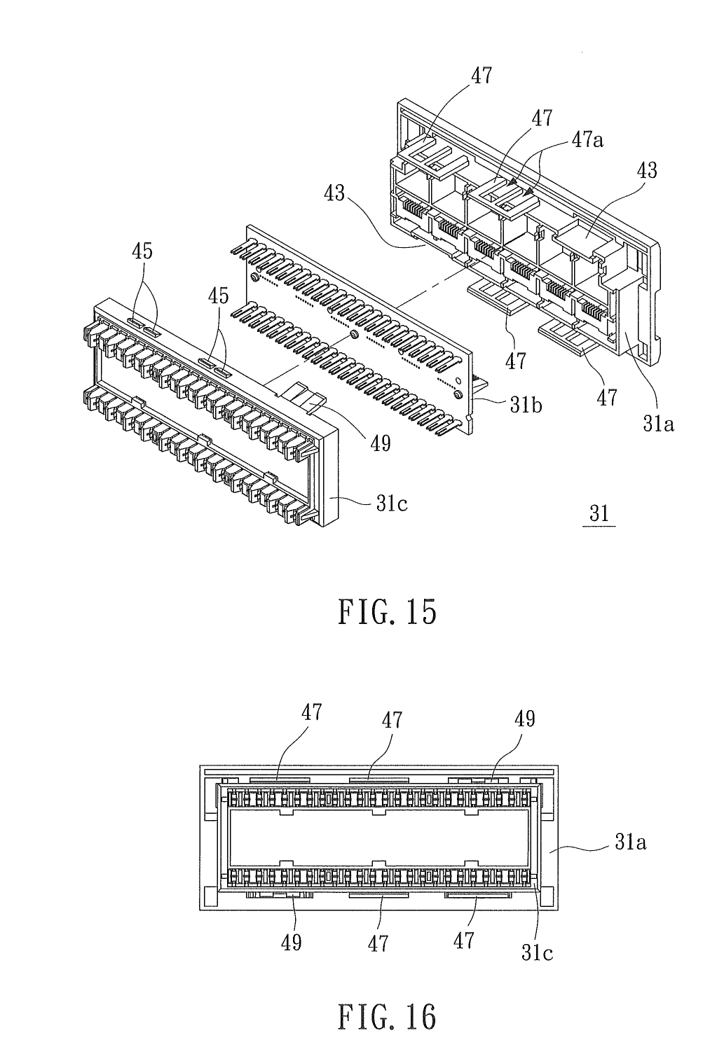

With reference to FIG. 15 for a perspective view of assembling a sliding cable hub body in accordance with a third preferred embodiment of the present invention, four slide latching portions 47 and two slide positioning portions 49 are used in the third preferred embodiment. Similarly, the slide latching portions 47 are designed on both upper and lower ends of the front panel 31a in accordance with this preferred embodiment to allow forces to be exerted uniformly onto the sliding cable hub body 31.

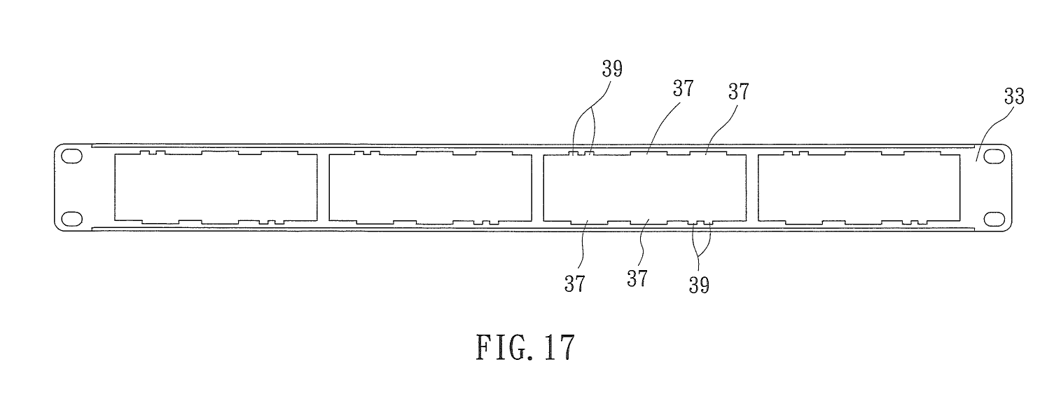

With reference to FIGS. 16 and 17 for a rear view of a sliding cable hub body and a schematic view of a fixed frame in accordance with a third preferred embodiment of the present invention respectively, FIG. 16 shows that four slide latching portions 47 are arranged alternately at upper and lower ends of the front panel 31a in this preferred embodiment to provide uniform forces for an easy assembling procedure. The two slide positioning portions 49 are installed on external sides of the upper and lower ends and also arranged alternately at the upper end lower ends of the front panel 31a. The fixed frame 33 includes a plurality of first slots 37 and a plurality of second slots 39 corresponding to the slide latching portions 47 and the two slide positioning portions 49 as shown in FIG. 17.

In summation of the description above, the present invention adopts a horizontal sliding method with the slide latching portions and the slide positioning portions to provide an easy and quick way of assembling the network wiring device.

While the invention has been described by means of specific preferred embodiments, numerous modifications and variations could be made thereto by those skilled in the art without departing from the scope and spirit of the invention set forth in the claims.

What is claimed is:

1. An easily installable network wiring device, comprising:
a sliding cable hub body, having at least one network interface installed thereon, two slide latching portions and a slide positioning portion formed on both upper and lower ends of the sliding cable hub body respectively; and
a fixed frame, having an opening for sliding the sliding cable hub body horizontally and accommodating the sliding cable hub body, and a plurality of first slots and a plurality of second slots disposed at an edge of the opening for accommodating the slide latching portions and the slide positioning portions respectively;
wherein the sliding cable hub body is installed into the fixed frame through the opening, and slid horizontally along the edge of the opening, such that the slide latching portions and the corresponding first notches are arranged alternately with one another, and the slide positioning portions are aligned with the second notches to achieve a fixed status, so as to latch the sliding cable hub body with the fixed frame.

2. The easily installable network wiring device of claim 1, wherein the sliding cable hub body includes a positioning groove formed at a central position of both upper and lower ends separately, such that if it is necessary to remove the sliding cable hub body from the fixed frame, a pressure is applied to press the slide positioning portions into the corresponding positioning grooves to release the fixed status.

3. The easily installable network wiring device of claim 2, further comprising a first ditch disposed between a rear end of the slide latching portions and an external panel of the sliding cable hub body separately, and the first ditches allow the sliding cable hub body to slide horizontally on the fixed frame.

4. The easily installable network wiring device of claim 3, further comprising a positioning gap disposed between the slide positioning portions and the external panel of the front panel, and the positioning gap is narrower than the first ditch.

5. The easily installable network wiring device of claim 1, wherein each slide positioning portion includes two protrusions corresponding to two ports of each second notch respectively.

6. The easily installable network wiring device of claim 1, wherein the sliding cable hub body further comprises a front panel and a rear panel, and the slide latching portion is formed on two external sides of the upper and lower ends of the front panel separately, and the slide positioning portion is formed at the central position of the upper and lower ends of the rear panel separately.

7. The easily installable network wiring device of claim 6, further comprising a positioning groove formed at a central position of the upper and lower ends of the front panel separately, such that if it is necessary to remove the sliding cable hub body from the fixed frame, a pressure is applied to press the slide positioning portions into the corresponding positioning grooves to release the fixed status.

8. The easily installable network wiring device of claim 7, further comprising a first ditch disposed between a rear end of the slide latching portions and an external panel of the front panel separately for sliding the sliding cable hub body horizontally on the fixed frame.

9. The easily installable network wiring device of claim 8, further comprising a positioning gap disposed between the slide positioning portions and the external panel of the front panel separately, and the positioning gaps being narrower than the first ditches.

10. The easily installable network wiring device of claim 6, further comprising a circuit board installed between the front panel and the rear panel for electrically connecting the network interfaces.

11. The easily installable network wiring device of claims 6, further comprising a hook portion formed on two external sides of the upper and lower ends of the rear panel separately, and the positions of the hook portions being corresponding to positions for latching the U-shaped slots of the slide latching portions respectively, such that the front panel and the rear panel are fixed with one another by latching the hook portions with the U-shaped slots.

12. The easily installable network wiring device of claim 11, wherein each slide positioning portion includes two protrusions corresponding to two ports of each second notch respectively.

13. An easily installable network wiring device, comprising:
a sliding cable hub body, having at least one network interface installed thereon, a slide latching portion formed at both upper and lower ends separately, and a slide positioning portion formed at one of the upper and lower ends; and
a fixed frame, having an opening for sliding the sliding cable hub body horizontally and accommodating the sliding cable hub body, and a plurality of first slots and a plurality of second slots disposed at an edge of the opening for accommodating the slide latching portions and the slide positioning portions respectively;
wherein the sliding cable hub body is installed into the fixed frame through the opening, and slid horizontally along the edge of the opening, such that the slide latching portions and the corresponding first notches are arranged alternately with one another, and the slide positioning portions are aligned with the second notches to achieve a fixed status, so as to latch the sliding cable hub body with the fixed frame.

14. The easily installable network wiring device of claim 13, wherein the sliding cable hub body forms a positioning groove at a central position of both upper and lower ends separately, such that if it is necessary to remove the sliding cable hub body from the fixed frame, a pressure is applied to press the slide positioning portions into the corresponding positioning grooves to release the fixed status.

15. The easily installable network wiring device of claim 14, further comprising a first ditch disposed between a rear end of the slide latching portions and an external panel of the sliding cable hub body separately, and the first ditches allow the sliding cable hub body to slide horizontally on the fixed frame.

16. The easily installable network wiring device of claim 15, further comprising a positioning gap disposed between the slide positioning portions and the external panel of the front panel, and the positioning gap is narrower than the first ditch.

17. The easily installable network wiring device of claim 13, wherein the slide positioning portion includes two protrusions corresponding to two ports of each second notch respectively.

18. The easily installable network wiring device of claim 13, wherein the sliding cable hub body further comprises a front panel and a rear panel, and the slide latching portion is formed at upper and lower ends of the front panel separately, and the slide positioning portion is formed at one of the upper and lower ends of the rear panel.

19. The easily installable network wiring device of claim 18, further comprising a positioning groove formed at the upper and lower ends of the front panel separately and disposed at an end corresponding to the slide positioning portion, such that if it is necessary to remove the sliding cable hub body from the fixed frame, a pressure is applied to press the slide positioning portions into the corresponding positioning grooves to release the fixed status.

20. The easily installable network wiring device of claim 19, further comprising a first ditch disposed between a rear end of the slide latching portions and an external panel of the front panel separately for sliding the sliding cable hub body horizontally on the fixed frame.

21. The easily installable network wiring device of claim 20, further comprising a positioning gap disposed between the slide positioning portions and the external panel of the front panel, and the positioning gap being narrower than the first ditches.

22. The easily installable network wiring device of claim 18, further comprising a circuit board installed between the front panel and the rear panel for electrically connecting the network interfaces.

23. The easily installable network wiring device of claims 18, further comprising a hook portion formed at the upper and lower ends of the rear panel separately, and the positions of the hook portions corresponding to positions for latching the U-shaped slots of the slide latching portions respectively, such that the front panel and the rear panel are fixed with one another by latching the hook portions with the U-shaped slots.

24. The easily installable network wiring device of claim 23, wherein each slide positioning portion includes two protrusions corresponding to two ports of each second notch respectively.

25. The easily installable network wiring device of claim 13, wherein the slide latching portion is formed separately at the central position of both upper and lower ends of the sliding cable hub body, and the slide positioning portion is formed at an external edge of one of the upper and lower ends of the sliding cable hub body.
